(19) United States
(12) Patent Application Publication
(10) Pub. No.: US 2003/0130897 A1
(43) Pub. Date: Jul. 10, 2003

(54) System and method for automatic addition to online shopping carts

(76) Inventors: Clifford A. Pickover, Yorktown Heights, NY (US); Paul A. Moskowitz, Yorktown Heights, NY (US); Stephen J. Boies, Mahopac, NY (US); William Grey, Millwood, NY (US)

Correspondence Address: BUCKLEY, MASCHOFF, TALWALKAR, & ALLISON, 5 ELM STREET, NEW CANAAN, CT, 06840, US

(21) Appl. No.: 10/041,130

(22) Filed: Jan. 7, 2002

(51) Int. Cl. G06F 17/60

(52) U.S. Cl. 705/26

(57) ABSTRACT

An online shopping cart is provided including an item associated with the shopping cart in response to a selection of the item by a consumer and an item associated with the shopping cart in response to a selection of the item by an entity other than the consumer. Also provided is an online shopping cart including an item associated with the shopping cart in response to a selection of the item by a consumer, and an item not selected by the consumer to be associated with the shopping cart.

### CROSS-REFERENCE TO RELATED APPLICATIONS

This application is related to the following co-pending and commonly assigned U.S. Patent Applications (the content of each of which is hereby incorporated by reference herein for all purposes):

U.S. Patent Application Serial No. ______, filed ______ (on even date herewith) for “SYSTEM TO FACILITATE ELECTRONIC SHOPPING” (Attorney Docket No. I01.045 and Client Docket No. YOR920010378US1); and

U.S. Patent Application Serial No. ______, filed ______ (on even date herewith) for “OPTIMIZED SHOPPING CART” (Atty. Docket No. I01.046 and Client Docket No. YOR920010377US1).

### BACKGROUND OF THE INVENTION

1. Field of the Invention

The present invention relates to electronic shopping. Specifically, the present invention concerns electronic shopping systems utilizing online shopping carts.

2. Description of the Related Art

Online stores are fast becoming ubiquitous. A particular online store is often an electronic version of a corresponding brick-and-mortar store. For example, the website located at http://www.CircuitCity.com provides an online store that sells items similar to those sold by conventional Circuit City stores. Some merchants, such as Amazon.com, provide online stores for which no brick-and-mortar counterparts exist.

In a typical online store, a consumer browses Web pages provided by a website. The website is operated by a merchant or by an entity that the merchant has employed for this purpose, and the Web pages present descriptions, pictures and prices of items for sale. The Web pages are organized hierarchically according to item type, and are browsed by selecting hyperlinks included therein. Once a consumer identifies an item for purchase, the consumer inputs a command to add the item to his “shopping cart”. This shopping cart is roughly an online equivalent of a conventional shopping cart, in that a consumer associates items with the online shopping cart and proceeds to “checkout”, where the items associated with the online shopping cart are purchased. Once a particular item is associated with an online shopping cart, it must be disassociated from the cart in order to purchase other items in the cart without also purchasing the particular item.

Accordingly, association of an item with an online shopping cart is a significant step towards the purchase of the item. More specifically, an item must first be associated with an online shopping cart before the item may be purchased. Also, due to the extra step required to disassociate an associated item, simply associating an item with an online shopping cart increases the possibility that a consumer will purchase the item. Therefore, merchants desire systems that increase an amount of items that are associated with online shopping carts.

### SUMMARY OF THE INVENTION

In order to address the foregoing, the present invention provides a method, an apparatus, a system, a medium, and means to associate an online shopping cart with a consumer, and to associate an item with the online shopping cart, wherein the associated item was not selected by the consumer for association with the shopping cart. In related embodiments, the present invention provides an online shopping cart including an item associated with the shopping cart in response to a selection of the item by a consumer and an item associated with the shopping cart in response to a selection of the item by an entity other than the consumer. As a result of these features, merchants may sell more items to the consumer than would be sold using conventional systems.

In other aspects, the present invention includes association of an online shopping cart with a consumer, and association of an item with the online shopping cart in response to a selection of the item by an entity other than the consumer. Along these lines, the invention may also provide an online shopping cart including an item associated with the shopping cart in response to a selection of the item by a consumer, and an item not selected by the consumer to be associated with the shopping cart. Embodiments of each of these aspects may facilitate the association of items with an online shopping cart by allowing entities other than the consumer to associate the items. Accordingly, these embodiments increase a likelihood that the items will be purchased.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps of online shopping according to embodiments of the present invention.

FIG. 2 is a topographic view of a network architecture according to embodiments of the present invention.

FIG. 3 is a block diagram of an internal architecture of a store server according to embodiments to the present invention.

FIG. 4 is a block diagram of an internal architecture of a consumer device according to embodiments to the present invention.

FIG. 5 is a representative view of a tabular portion of an item database according to embodiments of the present invention.

FIG. 6 is a representative view of a consumer database according to embodiments of the present invention.

FIG. 7 is a representative view of a tabular portion of a shopping cart database according to embodiments of the present invention.

FIGS. 8A and 8B comprise a flow diagram of process steps to provide an online shopping cart according to embodiments of the present invention.

FIG. 9 is a representative view of a display presenting data according to embodiments of the present invention.

FIG. 10 is a representative view of a display presenting data according to embodiments of the present invention.

FIG. 11 is a representative view of a display presenting data according to embodiments of the present invention.

### DETAILED DESCRIPTION

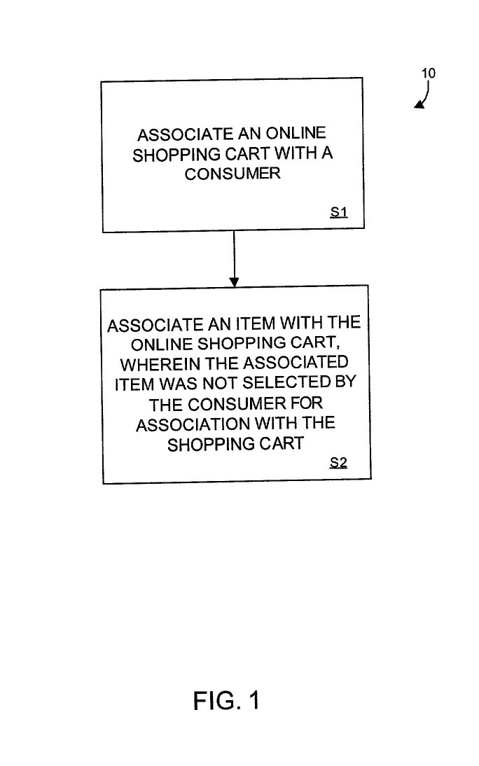

FIG. 1 is a flow diagram of steps 10 of an online shopping process according to some embodiments of the present invention. In order to provide an immediate introduction to features of the present invention, process steps 10 will be generally described with reference to one particular embodiment. Of course, complete descriptions of other specific hardware and software embodiments of the claimed invention are set forth below.

In the particular embodiment, a consumer operates a Web browser so as to access Web pages provided by an online store. During such access, the online store associates an online shopping cart with the consumer in step S1. The consumer navigates the Web pages to select items to associate with the online shopping cart. In addition to the consumer-selected items, one or more other items are associated with the online shopping cart in step S2.

The “other” items are items that were not selected by the consumer for association with the online shopping cart. In the present specific example, the other items are items that are complementary to the consumer-selected items. Also, the other items are selected by the online store for association with the online shopping cart. The other items may, according to other embodiments, be selected based on other or additional criteria and by any entity other than the consumer. Additionally, the other items may be associated with the shopping cart at any time before or during communication between the consumer and the online store. Several examples of each of these variations are set forth below.

By virtue of process steps 10, an item may be associated with a consumer's online shopping cart in order to increase a likelihood that the item will be purchased by the consumer.

Network Architecture

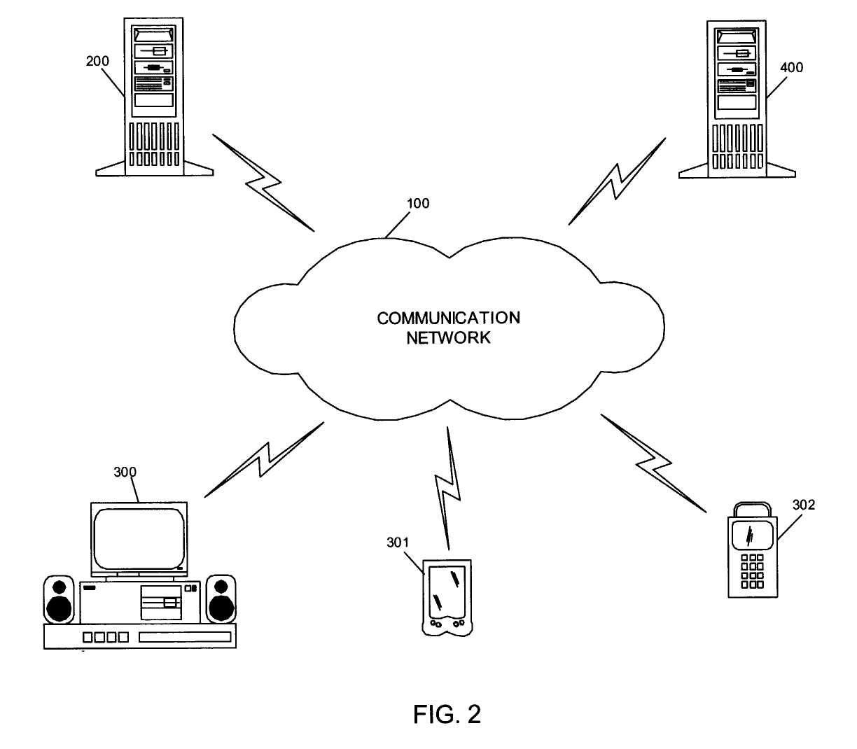

FIG. 2 is a topographic view of a network architecture according to embodiments of the present invention. Of course, network architectures other that that shown in FIG. 2 may be used to implement the invention.

FIG. 2 shows communication network 100 in communication with store server 200, consumer devices 300 to 302 and association server 400. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

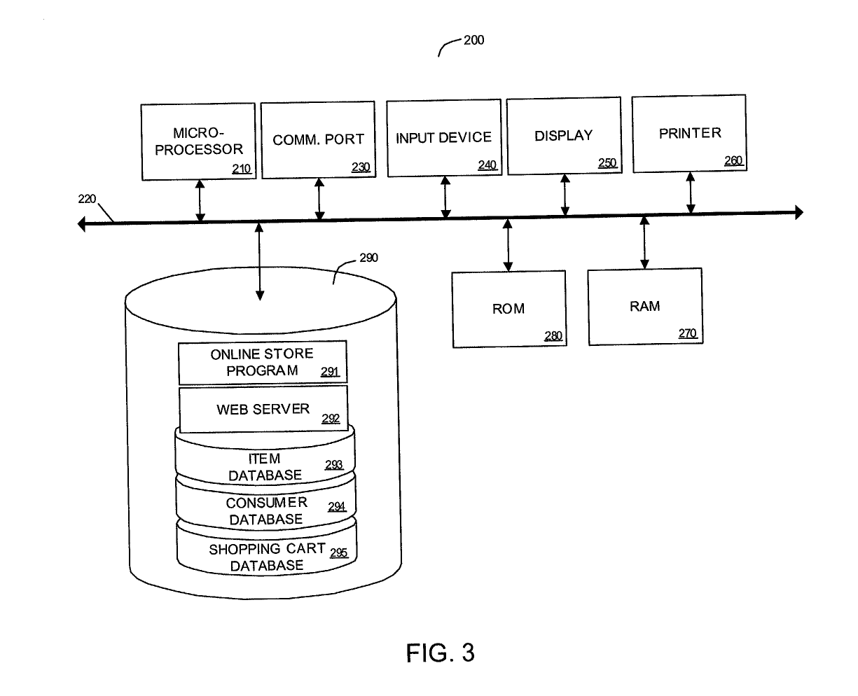

Store server 200 may comprise a Web server, local area network server or other device capable of performing steps according to the present invention. According to some embodiments, store server 200 operates to associate an online shopping cart with a consumer, and to associate an item with the online shopping cart, wherein the associated item was not selected by the consumer for association with the shopping cart. Also in some embodiments, store server 200 performs the steps of associating an online shopping cart with a consumer, and associating an item with the online shopping cart in response to a selection of the item by an entity other than the consumer. Store server 200 may also control various operations of an entity providing an online store, such as billing, accounting, sales tracking and the like. It should be noted that store server 200 may also perform functions unrelated to an online store. Details of one embodiment of store server 200 are set forth below with respect to FIG. 3.

Consumer devices 300 to 302 of FIG. 2 comprise a desktop computer, a personal digital assistant (PDA) and a cellular telephone. A consumer device according to the invention may comprise any device or devices for transmitting electronic data over communication network 100. Specifically, any one of consumer devices 300 to 302 may be used to present an online shopping cart including an item associated with the shopping cart in response to a selection of the item by a consumer and an item associated with the shopping cart in response to a selection of the item by an entity other than the consumer. Accordingly, consumer devices 300 to 302 may also be used to present an online shopping cart including an item associated with the shopping cart in response to a selection of the item by a consumer, and an item not selected by the consumer to be associated with the shopping cart. Of course, consumer devices 300 to 302 may also be used by a consumer for other functions, such as word processing, scheduling, e-mail, telephone communication, or the like.

Association server 400 may provide information based on which store server 200 associates an item not chosen by a consumer with an online shopping cart. Such information may include a shopping history of the consumer, a shopping history of one or more other consumers, consumer preferences, complementary item information, demographic information, prices of similar items, promotions, marketing arrangements with manufacturers and distributors, inventory levels, projected demand, costs and profit margins. Of course, the foregoing information may be stored on server 200 as well.

It should be noted that the elements of FIG. 2 may be connected differently than as shown. For example, some or all of the elements may be connected directly to one another. Of course, embodiments of the invention may include elements that are different from those shown. Moreover, although the illustrated communication links between the components of FIG. 2 appear dedicated, it should be noted that each of the links may be shared by other components. Additionally, elements shown in communication with each other need not be constantly exchanging data. Rather, communication may be established when necessary and severed at other times or always available but rarely used to transmit data.

Store Server

FIG. 3 is a block diagram of the internal architecture of store server 200 according to one embodiment of the invention. As illustrated, store server 200 includes microprocessor 210 in communication with communication bus 220. Microprocessor 210 may be a Pentium™, RISC™, or other type of processor and is used to execute processor-executable process steps so as to control the components of store server 200 to provide functionality according to embodiments of the present invention.

Also in communication with communication bus 220 is communication port 230. Communication port 230 is used to transmit data to and to receive data from devices external to store server 200. Communication port 230 is therefore preferably configured with hardware suitable to physically interface with desired external devices and/or network connections. In some embodiments, selections of items to associate with online shopping carts are received from consumers and from other entities over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating store server 200 to input item information, consumer information, billing information, and other information to store server 200. Of course, such information may also be input to store server 200 via communication port 230. Commands for controlling operation of store server 200 may also be input using input device 240.

Display 250 may be an integral or separate CRT display, a flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, online store program 291 of processor-executable process steps. Microprocessor 210 executes process steps of online store program 291 in order to control store server 200 to operate an online store. For example, the process steps may be executed to associate an online shopping cart with a consumer, and to associate an item with the online shopping cart, wherein the associated item was not selected by the consumer for association with the shopping cart

The process steps of online store program 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Process steps of Web server 292 are also stored in data storage device 290 and may be executed to provide a website, such as an online store, to a Web client, such as a Web browser executing in consumer device 300. In order to provide a website, Hypertext Transfer Protocol (HTTP) requests are received from a Web client and, in response, appropriate Web pages are created and sent to the Web client. In the example of FIG. 3, the Web pages may be created by one or both of online store program 291 and Web browser 292.

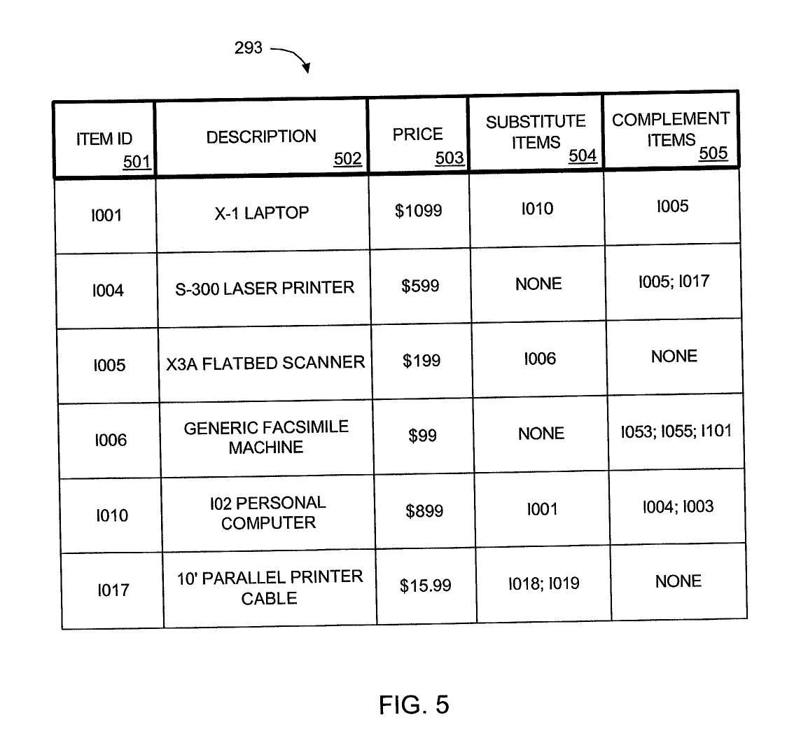

Data storage device 290 also stores item database 293, consumer database 294 and shopping cart database 295. Item database 293 stores information regarding items for sale. Such information may include a description, a price, information relating to complementary items, information relating to substitute items or the any other item-related information. One example of item database 293 is described below with respect to FIG. 5.

Consumer database 294 provides information regarding consumers. The information may include preferences, demographic information, purchase history, credit limit, or the like. The information stored in consumer database 294 may be used to determine what type of item to associate with an online shopping cart that is associated with a consumer.

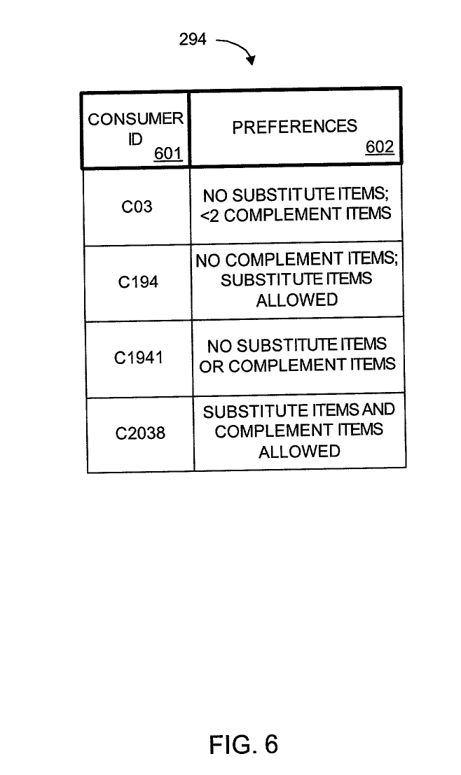

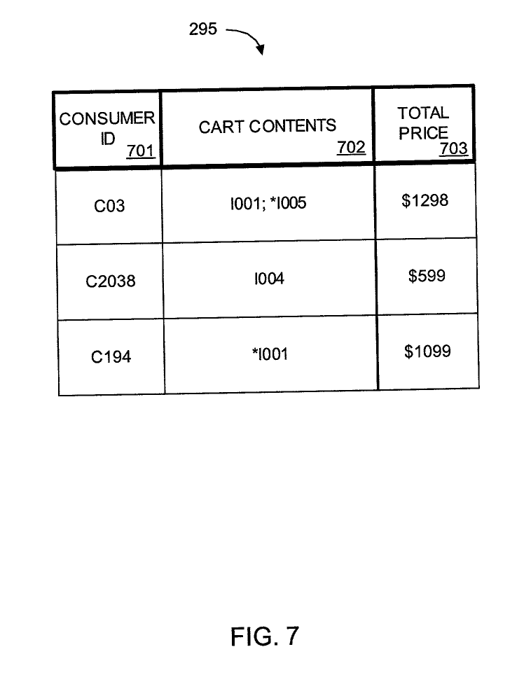

Each online shopping cart provided by store server 200 is represented by a record of shopping cart database 295. Accordingly, each of these records specifies items associated with its represented shopping cart, as well as information such as a total price of the items, an identity of a consumer with whom the shopping cart is associated, or the like. Representative examples of consumer database 294 and shopping cart database 295 are shown in FIGS. 6 and 7, respectively.

Stored in data storage device 290 may also be other unshown elements that may be necessary for operation of store server 200, such as other applications, other data files, a network server, an operating system, a database management system and “device drivers” for allowing microprocessor 210 to interface with devices in communication with communication port 230. These elements are known to those skilled in the art, and are therefore not described in detail herein.

Consumer Device

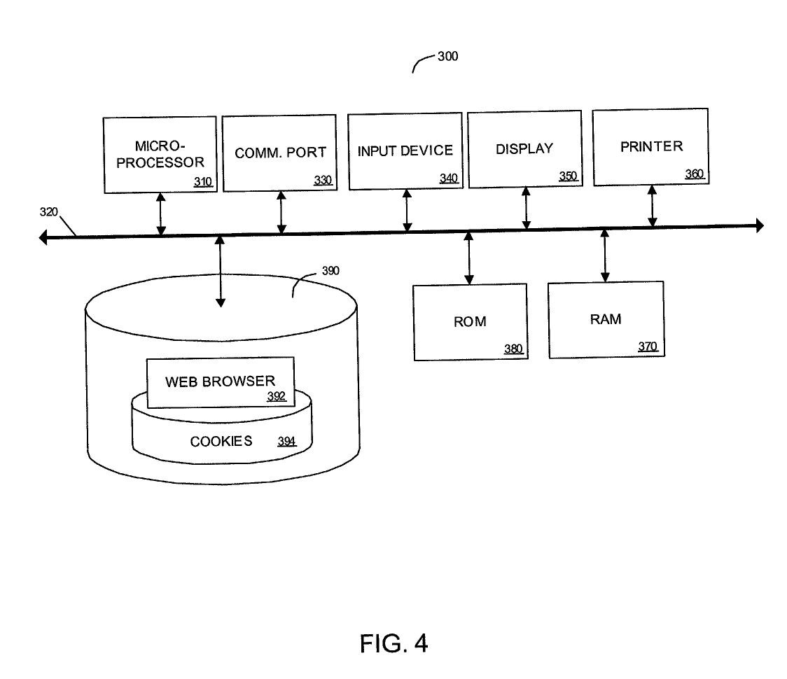

FIG. 4 illustrates several components of consumer device 300 according to embodiments of the invention. The components may comprise any of the specific examples set forth above with respect to identically-named components of store server 200. Of course, specific functions performed by the components may differ from the functions performed by the identically-named components.

In this regard, communication port 330 may be used to transmit requests for information such as Web pages and to receive the information from store server 200. Input device 340 may be used to browse received Web pages and to issue instructions to associate items with an online shopping cart, and printer 360 may be used to print out a purchase receipt. Display 350 may present an online shopping cart to a consumer, such as an online shopping cart including an item associated with the shopping cart in response to a selection of the item by the consumer, and an item associated with the shopping cart in response to a selection of the item by an entity other than the consumer. Input device 340, display 350 and printer 360 may also be used in conjunction with functionality provided by consumer device 300 that is unrelated to the present invention.

Data storage device 390 stores Web browser 392, which is executed by microprocessor 310 and operated by a consumer to access, browse and download information such as Web pages from Web servers supporting HTTP communication. As described herein, such Web pages may comprise an online store. Web browser 392 may also be used to transmit information to Web servers.

Data storage device 390 also stores cookies 394. As is known to those skilled in the art of Web browsers, a cookie is stored on a device by a Web server during a session between the device and the Web server in order to provide identification and other information to the Web server during subsequent sessions with the device. In this regard, a cookie might specify a name of a consumer operating the device, preferences of the consumer, demographic information relating to the consumer, a consumer profile, a list of items purchased by the consumer, etc. Cookies stored among cookies 394 may be used in accordance with the present invention to determine an item to associate with an online shopping cart. Such a use will be described in detail below.

Data storage device 390 may also store application files, data files and system files other than those shown in FIG. 4. These files may be used by consumer device 300 to provide various functionalities to a consumer in addition to those provided by the present invention.

Item Database

A tabular representation of a portion of item database 293 is shown in FIG. 5. The information stored in item database 293 may be entered by an operator of store server 200 through input device 240 or may be received from another device such as association server 400 over communication network 100. The stored information provides details regarding items offered for sale by an online store according to the present invention.

Item database 293 includes several records and associated fields. The fields include item ID field 501, description field 502, price field 503, substitute items field 504, and complement items field 505. Item ID field 501 of a record represents an item associated with the record that is offered for sale by store server 200, and provides a shorthand notation for referring to the item. Description field 502 provides a description of an item that may be presented to a consumer so that the consumer may identify the item, and price field 503 specifies the retail price of an associated item.

Substitute items field 504 of a record specifies one or more items that may be substituted for an associated item. Similarly, complement items field 505 of the record identifies items complementary to the associated item. Complementary items may be similar to the associated item, as a book written by an author is similar to other books by the author, usable with the associated item, as a baseball is usable with a baseball glove, or part of a set including the associated item, as a spoon is a part of a set including a fork.

Accordingly, fields 504 and 505 may be used to determine items to associate with an online shopping cart that have not been chosen by a consumer to be associated with the shopping cart. More specifically, if a particular item is chosen by a consumer to be associated with an online shopping cart, an item identified in substitute items field 504 of a record associated with the particular item may be associated with the online shopping cart instead. Also, an item identified in complement items field 505 of the record may be associated with the online shopping cart. The information stored in fields 504 and 505 may be provided from association server 400, from manufacturers, from market research companies, or from other entities.

Of course, item database 293 may include information in addition to or instead of that shown in FIG. 5. For example, item database 293 may include warranty information, manufacturer information, or the like. Moreover, an item represented in item database may comprise any type of good and/or service, including merchandise, stocks, bonds, promises, and knowledge.

Consumer Database

Consumer database 294 of FIG. 6 includes information relating to consumers. Each record of database 294 is associated with a consumer, and includes consumer ID field 601 and preferences field 602. Information stored in each record may be used to determine items to associate with an online shopping cart that were not chosen by a consumer. The information stored in consumer database 294 may be received from cookies 394, from association server 400, directly from consumers through a survey or registration process, or from entities providing consumer information.

With respect to the specific fields, consumer ID field 601 of a record includes an identifier of a consumer who is the subject of the record. Preferences field 602 specifies any type of consumer preference information that may be used as described above. Such information includes, but is not limited to, preferences for associating complementary items with a shopping cart, and preferences for associating substitute items with a shopping cart.

Shopping Cart Database

FIG. 7 shows a tabular representation of a portion of shopping cart database 295 according to some embodiments of the present invention. Shopping cart database 295 includes information usable to track items associated with online shopping carts provided by store server 200.

Specifically, each record in shopping cart database 295 includes consumer ID field 701, cart contents field 702, and total price field 703. Accordingly, each record represents a distinct online shopping cart. A record may represent an online shopping cart including an item associated with the shopping cart in response to a selection of the item by a consumer associated with the shopping cart, and a second item associated with the shopping cart in response to a selection of the second item by an entity other than the consumer. Moreover, a record may represent an online shopping cart including an item associated with the shopping cart in response to a selection of the item by a consumer associated with the shopping cart, and a second item not selected by the consumer to be associated with the shopping cart. A record of shopping cart database 295 may be created for a consumer once the consumer logs on to an online store, once the consumer chooses to associate an item or items with an online shopping cart, or at any other appropriate time.

Consumer ID field 701 of a record includes an identifier specifying a consumer with whom the record is associated. The identifier may therefore also be used to identify a shopping cart associated with the consumer. Cart contents field 702 includes identifiers specifying items associated with the shopping cart. An identifier of an item may be stored in cart contents field 702 in response to an instruction from a consumer to associate the item with an online shopping cart. In some embodiments, an identifier of an item is stored in cart contents field 702 in response to an instruction from an entity other than the consumer to associate the item with the online shopping cart. In the embodiment shown in FIG. 7, identifiers of items that have not been chosen by a consumer to be associated with the consumer's online shopping cart are flagged in cart contents field 702 with an asterisk.

Total price field 703 specifies a total price to be charged to a consumer for all items associated with an associated shopping cart. The total price may be a sum of the retail prices of all items specified in associated cart contents field 702, or may reflect a discount or a premium applied to the sum of retail prices. In some embodiments, an associated item that was not selected by the consumer is free.

It is contemplated that each of item database 293, consumer database 294 and shopping cart database 295 may include many more records than those shown and that each record may include associated fields other than those illustrated. It should also be noted that the tabular illustrations and accompanying descriptions of the databases merely represent relationships between stored information. A number of other arrangements may be employed besides those suggested.

### SPECIFIC EXAMPLE

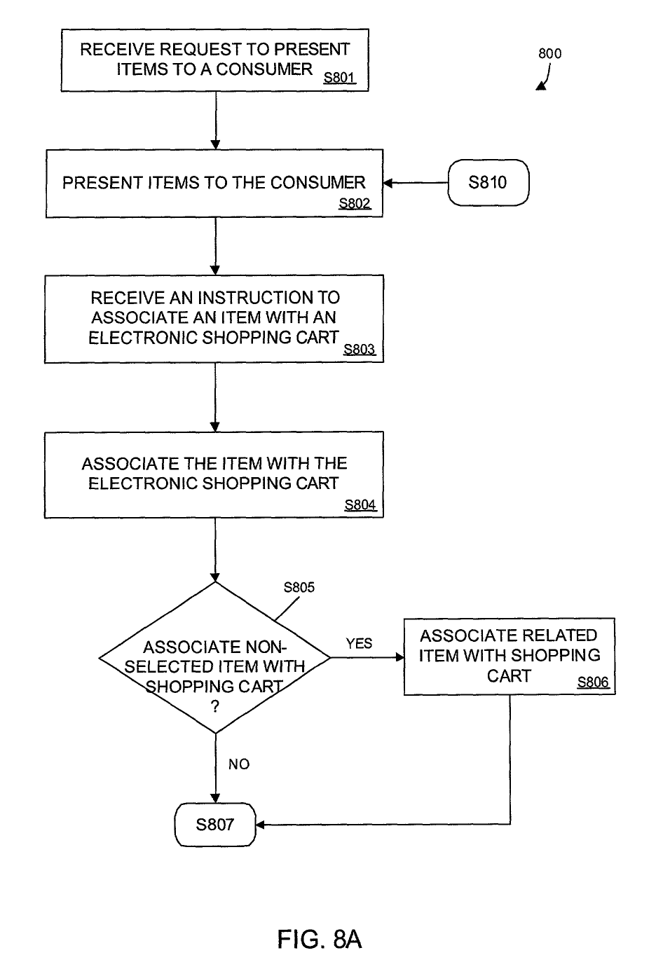

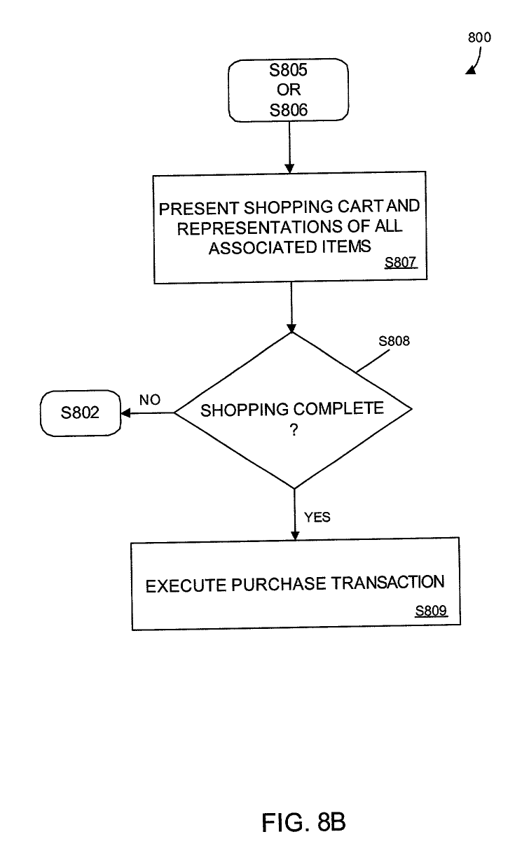

Process steps 800 of FIGS. 8A and 8B set forth an electronic shopping process according to some embodiments of the present invention. Process steps 800 are described below as if included in online store program 291 and executed by microprocessor 210 of store server 200. Of course, it should be noted that process steps 800 may be performed by any device or by any number of devices in combination, including consumer device 300 and control device 400. Moreover, some or all of process steps 800 may be performed manually.

Process steps 800 begin at step S801, in which a request is received to present items to a consumer. In some embodiments, the request is transmitted by Web browser 392 executing in consumer device 300. More specifically, a consumer uses input device 340 to input a Uniform Resource Locator (URL) into a window displayed on display 350 by Web browser 392. In response, an IP address corresponding to the URL is retrieved from a Domain Name Server and a request is sent via HTTP to the IP address. According to this example, the IP address corresponds to store server 200, therefore the request is received in step S801 by store server 200.

In an online store embodiment, the request may be received in step S801 while a consumer operates Web browser 394 to browse Web pages of the online store. Accordingly, the request may request access of a specific Web page of the online store. For example, the request may comprise a selection of a hyperlink to a Web page presenting computing-related items.

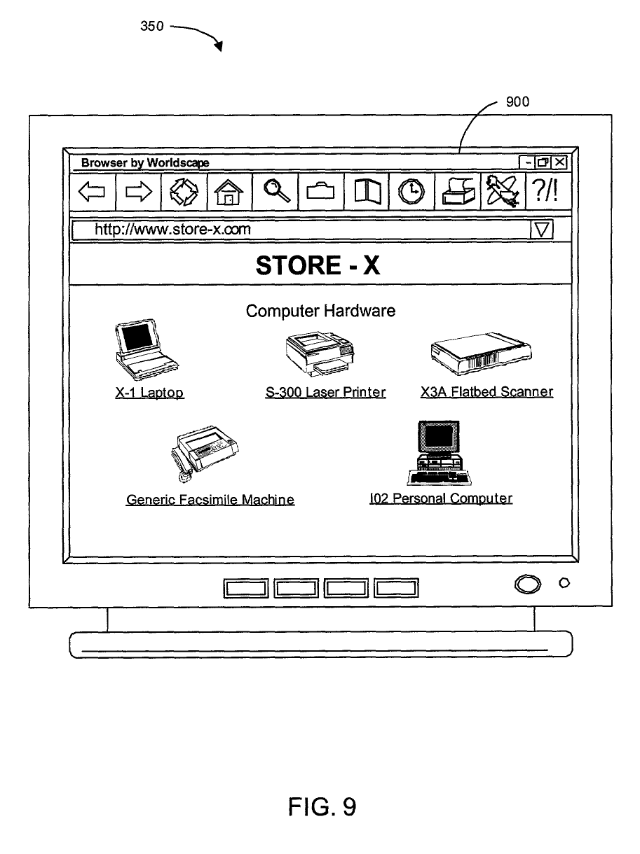

In response to the request, items are presented to the consumer in step S802. In a particular example of step S802, Web server 292 of server 200 creates an HTML page presenting the items in conjunction with online store program 291 and transmits the page to consumer device 300. FIG. 9 is a representative view of display 350 presenting such a page. As shown, page 900 presents images of several items along with explanatory text.

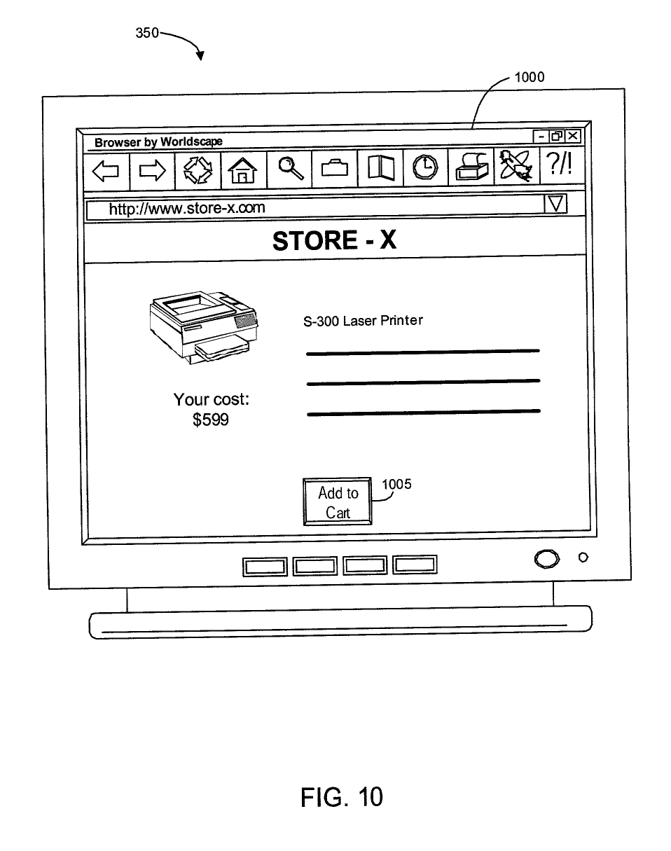

The consumer may select one of the presented items using input device 340, in response to which store server 200 creates and transmits an item detail page to consumer device 300. Item detail page 1000 of FIG. 10 is an example of an item detail page presented to the consumer upon selection of the “S-300 Laser Printer” from page 900. In this embodiment, item detail page 1000 presents an image of the selected item and text in addition to the explanatory text displayed in page 900. The image and the text may be retrieved from a record of item database 293 associated with the selected item.

Also included in item detail page 1000 is “Add to Cart” icon 1005. According to this example, “Add to Cart” icon 1005 is selected by the consumer to issue an instruction to associate the selected item with an online shopping cart associated with the consumer. The instruction is received in step S803. Next, in step S804, the item is associated with an online shopping cart associated with the consumer.

In order to associate the item with the online shopping cart, a record associated with the consumer is created in shopping cart database 295. More specifically, a record is created (if not previously created) in which consumer ID field 701 includes the consumer ID associated with the consumer, and in which an identifier representing the selected item populates cart contents field 702.

Next, in step S805, it is determined whether an item should be associated with the online shopping cart that was not selected by the consumer. In the present example, this determination proceeds by examining preferences field 602 of a record of consumer database 294 that is associated with the consumer in order to identify whether the consumer would like such items to be associated with the shopping cart. It will be assumed that the consumer is identified by the consumer ID “C2038”, therefore it is determined in step S805 that the consumer would like non-selected complementary and substitute items associated with the shopping cart.

Any such non-selected items are then identified in step S805 by referring to fields 504 and 505 associated with the selected item in item database 293. Any identified items are associated with the online shopping cart in step S806. The association may proceed as explained with respect to step S804, with the difference that the identifier identifying the non-selected item is flagged with an asterisk in the appropriate record. Flow then proceeds from step S806 to step S807. In this regard, flow also continues from step S805 to step S807 in a case that the determination in step S805 is negative.

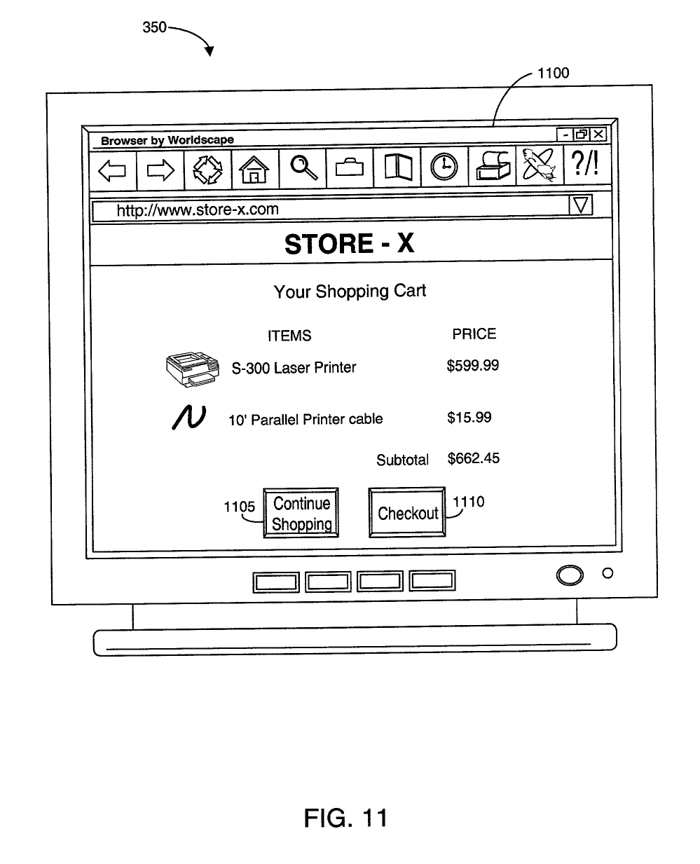

In step S807, the online shopping cart is presented to the consumer. Also presented in step S807 are representations of all items associated with the online shopping cart. Step S807 may include generation and transmission of a Web page illustrating the contents of the shopping cart. Such a process may be automatically performed after steps S805 or S806, or may be in response to a request from the consumer to view the contents of the cart. Web page 1100 of FIG. 11 is an example of a Web page illustrating the contents of the shopping cart. Accordingly, Web page 1100 includes, for each item associated with the shopping cart in shopping cart database 295, a description and a price associated with the item in item database 293.

In some embodiments, the representation of the non-selected item is accompanied by detailed terms for purchasing the item. Such terms may be presented in a pop-up window and include an explanation of why the item was associated with the shopping cart. Alternatively, the pop-up window may simply notify the consumer that a non-selected item was associated with the shopping cart. Also, in some embodiments, the representation graphically indicates that the item was not selected by the consumer for association with the shopping cart, and/or that the item was selected by an entity other than the consumer for association with the shopping cart.

Flow returns to step S802 from step S808 if the consumer selects “Continue Shopping” icon 1105 of Web page. Alternatively, flow proceeds to step S809 if the consumer selects “Checkout” icon 1110. In step S809, a purchase transaction is executed to sell to the consumer each item associated with the online shopping cart.

In some embodiments, the consumer may disassociate an item with the online shopping cart by issuing an instruction to disassociate the item, in response to which the item is disassociated from the cart. Such embodiments therefore advantageously allow a consumer to remove an item that he did not selected for association with his cart prior to step S809. In other embodiments, the item cannot be disassociated from the cart.

It should be noted that the invention may be used in conjunction with many systems for determining to associate an item not selected by a consumer with an online shopping cart associated with the consumer. Similarly, the present invention may be used with a myriad of systems for associating an item with an online shopping cart that was selected by an entity other than a consumer associated with the online shopping cart. Such systems may be based on static or dynamic rules, on a characteristic of items currently associated with the cart, including a number of the items, a value of the items, and a type of one or more of the items, and/or on a characteristic of the consumer, including age, sex, residence, income and shopping history. Aforementioned U.S. Patent Application Serial Nos. ______ (Atty. Docket No. I01.045 and Client Docket No. YOR920010378) and ______ (Atty. Docket No. I01.046 and Client Docket No. YOR920010377) generally concern systems in which such “non-consumer selected” items may be associated with a shopping cart.

Of course, embodiments of the invention may operate differently than the foregoing specific example. For example, store server 200 may provide an online store enabling a consumer to associate an item with an online shopping cart simply by dragging and dropping, cutting and pasting, or copying and pasting a presented representation of the item into a representation of the online shopping cart. Moreover, the presentation of the shopping cart may be based on style sheets, views and/or preferences specified by the consumer. In some embodiments, presentation of the shopping cart further includes presentation of advertising to the consumer based on items associated with the shopping cart.

As mentioned above, U.S. Patent Application Serial No. ______ (Atty. Docket No. I01.046 and Client Docket No. YOR920010377) concerns systems in which items may be associated with a shopping cart by entities other that a consumer associated with the shopping cart. Moreover, U.S. Patent Application Serial No. ______ (Atty. Docket No. I01.045 and Client Docket No. YOR920010378) relates to systems to associate items with an online shopping cart in response to consumer selection of an activity. Accordingly, embodiments of the invention may be used in conjunction with any of these systems to associate items with an online shopping cart that were not chosen by a consumer to be associated with the online shopping cart.

It should also be noted that the processes of the above-described embodiments may also be applied to a physical shopping cart. That is, the present invention may be embodied in a system in which items are associated with a physical shopping cart. The items may be associated by a store employee, a manufacturer's representative, or by any other entity other than a consumer associated with the shopping cart. Of course, the consumer may also associate items with the physical shopping cart by placing the items in the shopping cart.

Although the present invention has been described with respect to particular embodiments thereof, those skilled in the art will note that various substitutions may be made to those embodiments described herein without departing from the spirit and scope of the present invention.

What is claimed is:

1. A method for online shopping, comprising:
associating an online shopping cart with a consumer; and
associating an item with the online shopping cart,
wherein the associated item was not selected by the consumer for association with the shopping cart.

2. A method according to claim 1, wherein the item is associated with the shopping cart based on at least one of: a shopping history of the consumer; a shopping history of one or more other consumers; consumer preferences; complementary item information; demographic information; prices of similar items; promotions; marketing arrangements with manufacturers and distributors; inventory levels; projected demand; costs and profit margins.

3. A method according to claim 1, further comprising:
determining to associate the item with the online shopping cart based on a first item associated with the shopping cart.

4. A method according to claim 3, wherein the item is complementary to the first item.

5. A method according to claim 3, wherein the item is a substitute for the first item.

6. A method according to claim 1, further comprising:
determining to associate the item with the online shopping cart based on a characteristic of items previously associated with the shopping cart.

7. A method according to claim 6, wherein the characteristic comprises at least one of: a number of items; a value of the items; and a type of one or more of the items.

8. A method according to claim 1, further comprising:
determining to associate the item with the online shopping cart based on a characteristic of the consumer.

9. A method according to claim 8, wherein the characteristic comprises at least one of: age; sex; residence; income; and shopping history.

10. A method according to claim 1, wherein a cost of the associated item is less than a retail cost that would be charged to the consumer for the item if the item was selected by the consumer for association with the shopping cart.

11. A method according to claim 10, wherein the cost of the associated item is free.

12. A method according to claim 1, wherein the item cannot be disassociated from the shopping cart.

13. A method according to claim 1, further comprising:
receiving an instruction from the consumer to disassociate a second item from the shopping cart; and
in response to the instruction, automatically disassociating the item from the shopping cart.

14. A method according to claim 1, further comprising:
presenting terms for purchasing the item to the consumer.

15. A method according to claim 1, further comprising determining the association based on rules.

16. A method according to claim 15, further comprising:
dynamically updating the rules.

17. A method according to claim 1, further comprising:
notifying the consumer that the item was associated with the shopping cart.

18. A method for online shopping, comprising:
associating an online shopping cart with a consumer; and
associating an item with the online shopping cart in response to a selection of the item by an entity other than the consumer.

19. A method according to claim 18, wherein the entity is a potential seller of the item.

20. A method according to claim 18, wherein the entity is an intelligent agent.

21. A method according to claim 18, wherein a cost of the associated item is less than a retail cost that would be charged to the consumer for the item if the item was selected by the consumer for association with the shopping cart.

22. A method according to claim 18, wherein the item cannot be disassociated from the shopping cart.

23. A method according to claim 18, further comprising:
receiving an instruction from the consumer to disassociate a second item from the shopping cart; and
in response to the instruction, automatically disassociating the item from the shopping cart.

24. An online shopping cart associated with a consumer, comprising:
an item associated with the shopping cart in response to a selection of the item by the consumer; and
an item associated with the shopping cart in response to a selection of the item by an entity other than the consumer.

25. An online shopping cart associated with a consumer, comprising:
an item associated with the shopping cart in response to a selection of the item by the consumer; and
an item not selected by the consumer to be associated with the shopping cart.

26. A method for shopping, comprising:
associating a physical shopping cart with a consumer; and
associating an item with the physical shopping cart,
wherein the associated item was not selected by the consumer for association with the shopping cart.

27. A method according to claim 26, wherein the item is associated with the shopping cart based on at least one of: a shopping history of the consumer; a shopping history of one or more other consumers; consumer preferences; complementary item information; demographic information; prices of similar items; promotions; marketing arrangements with manufacturers and distributors; inventory levels; projected demand; costs and profit margins.

28. A method according to claim 26, further comprising:
determining to associate the item with the online shopping cart based on a first item associated with the shopping cart.

29. A method according to claim 28, wherein the item is complementary to the first item.

30. A method according to claim 28, wherein the item is a substitute for the first item.

31. A method according to claim 26, wherein a cost of the associated item is less than a retail cost that would be charged to the consumer for the item if the item was selected by the consumer for association with the shopping cart.

32. A method according to claim 31, wherein the cost of the associated item is free.

33. A medium storing processor executable process steps, the process steps comprising:
a step to associate an online shopping cart with a consumer; and
a step to associate an item with the online shopping cart,
wherein the associated item was not selected by the consumer for association with the shopping cart.

34. A medium according to claim 33, wherein the item is associated with the shopping cart based on at least one of: a shopping history of the consumer; a shopping history of one or more other consumers; consumer preferences; complementary item information; demographic information; prices of similar items; promotions; marketing arrangements with manufacturers and distributors; inventory levels; projected demand; costs and profit margins.

35. A medium according to claim 33, the process steps further comprising:
a step to determine to associate the item with the online shopping cart based on a first item associated with the shopping cart.

36. A medium according to claim 35, wherein the item is complementary to the first item.

37. A medium according to claim 35, wherein the item is a substitute or the first item.

38. A medium according to claim 33, wherein a cost of the associated item is less than a retail cost that would be charged to the consumer for the item if the item was selected by the consumer for association with the shopping cart.

39. A medium according to claim 38, wherein the cost of the associated item is free.

40. A medium storing processor executable process steps, the process steps comprising:
a step to associate an online shopping cart with a consumer; and
a step to associate an item with the online shopping cart in response to a selection of the item by an entity other than the consumer.

41. A medium according to claim 40, wherein the entity is a potential seller of the item.

42. A medium according to claim 40, wherein the entity is an intelligent agent.

43. An apparatus for electronic shopping, comprising:
a processor; and
a storage device in communication with the processor and storing instructions adapted to be executed by the processor to:
associate an online shopping cart with a consumer; and
associate an item with the online shopping cart,
wherein the associated item was not selected by the consumer for association with the shopping cart.

44. An apparatus according to claim 43, wherein the item is associated with the shopping cart based on at least one of: a shopping history of the consumer; a shopping history of one or more other consumers; consumer preferences; complementary item information; demographic information; prices of similar items; promotions; marketing arrangements with manufacturers and distributors; inventory levels; projected demand; costs and profit margins.

45. An apparatus according to claim 43, the instructions adapted to be executed by the processor to:
determine to associate the item with the online shopping cart based on a first item associated with the shopping cart.

46. An apparatus according to claim 45, wherein the item is complementary to the first item.

47. An apparatus according to claim 45, wherein the item is a substitute for the first item.

48. An apparatus according to claim 43, wherein a cost of the associated item is less than a retail cost that would be charged to the consumer for the item if the item was selected by the consumer for association with the shopping cart.

49. An apparatus according to claim 48, wherein the cost of the associated item is free.

50. An apparatus for electronic shopping, comprising:
a processor; and
a storage device in communication with the processor and storing instructions adapted to be executed by the processor to:
associate an online shopping cart with a consumer; and
associate an item with the online shopping cart in response to a selection of the item by an entity other than the consumer.

51. An apparatus according to claim 50, wherein the entity is a potential seller of the item.

52. An apparatus according to claim 50, wherein the entity is an intelligent agent.
